(19) United States
(12) Patent Application Publication
(10) Pub. No.: US 2007/0297319 A1
(43) Pub. Date: Dec. 27, 2007

(54) Compression in Cable Data Service

(76) Inventor: Harold Gene Roberts, Carmel, IN (US)

Correspondence Address: THOMSON LICENSING LLC, Two Independence Way, Suite 200, PRINCETON, NJ, 08540, US

(21) Appl. No.: 11/660,850

(22) PCT Filed: Aug. 25, 2004
(86) PCT No.: PCT/US04/27529

§ 371 Date: Feb. 20, 2007

(51) Int. Cl. H04J 3/16; H04B 1/66

(52) U.S. Cl. 370/202

(57) ABSTRACT

A method for compression in cable data service includes the steps of providing data over protocol layers, and compressing at a data over cable service interface specification layer within the protocol layers. Compressing at the data over cable service interface specification layer includes compression at all layers of the protocol layers higher than the data over cable service interface specification layer.

### FIELD OF THE INVENTION

The present invention relates generally to data compression and, more particularly, to data compression for data service through cable modems.

### BACKGROUND OF THE INVENTION

The Data Over Cable Service Interface Specification (DOCSIS®) and the European Data Over Cable Service Interface Specification (Euro-DOCSIS) define interface standards for cable modems and supporting equipment. Cable companies want the data throughput performance of their cable modem service to be competitive with DSL data service. ADSL data service provides 1.5-9 Mbps downstream and 16-640 kbps upstream. VDSL can provide 13-52 bps downstream and 1.5-2.3 Mbps upstream. To meet the upstream rates needs of its business customers the cable industry recently updated the Data Over Cable Service Interface Specification (DOCSIS®). The DOCSIS/Euro-DOCSIS cable modem specifications now supports 256 quadrature amplitude modulation (QAM) in both the downstream and upstream. However, the HFC network limits the bandwidth available for upstreams and downstreams, and the quality of the HFC network may limit the maximum modulation to 256 QAM or less. By applying data compression techniques, often used in the analog telephone modems, in the DOCSIS/Euro-DOCSIS specifications for cable modem then the cable data service can provide higher effective throughput using the existing HFC network.

In the telecommunications industry, data compression with “high-speed” analog telephone modems has been used to provide videophone service. The modulation technology used in analog telephone modems (ITU-T V.34, ITU-T V.90, ITU-T V.92) improved over time but gradually approached the theoretical limit for the bandwidth limited voice telephone network. The analog telephone modem industry improved the performance of the analog telephone modem by improving the data compression algorithms used (e.g., Microcom Networking Protocol (MNP) 5, ITU-T V.42bis, and later ITU-T V.44). Similar data compression methods could be used in the cable modem industry to increase the effective throughput of cable-based data services.

The cable industry has used the following methods to increase effective throughput: A) upstream: use advanced modulation, e.g., moving from QPSK and 16 QAM (“Data-Over-Cable Service Interface Specifications—Radio Frequency Interface Specification (DOCSIS®)” SP-RFIv1.1-I10-030730) to 256 QAM and S-CDMA (“Data-Over-Cable Service Interface Specifications—Radio Frequency Interface Specification” SP-RFIv2.0-I04-030730); B) upstream: increase bandwidth available to the upstream channel (SP-RFIv1.1-I10-030730); C) downstream: bandwidth is limited to 6 MHz in ITU-T J.83-B networks and 8 MHz in ITU-T J.83-A networks (SP-RFIv2.0-104-030730); D) downstream: use 64 QAM up to 256 QAM modulation (SP-RFIv2.0-104-030730); E) header suppression/compression (SP-RFIv1.1-I10-030730). Modern HFC networks may be able to support up to 1024 QAM modulation but, like analog telephone modems, the modulation techniques suitable for HFC networks are approaching their theoretical performance limits.

Methods “A” and “D” use more complicated modulation to increase effective throughput. Using more complicated QAM modulation, such as 512 QAM and 1024 QAM, may not be possible due to the quality of the HFC networks. Method “B” uses increasing channel bandwidth to carry more data. Currently, the upstream channel bandwidth is limited to 6.4 MHz. While the DOCSIS/Euro-DOCSIS specifications could change to increase the channel bandwidth further to increase the upstream data throughput, it is unlikely because the total upstream frequency band is shared by all cable modems and further increases are limited to the total upstream frequency band (5-42 MHz). Method “C” is governed by national and international video standards so further increases to the downstream channel bandwidth to increase data throughput are unlikely. Method “E”, used in DOCSIS/Euro-DOCSIS version 1.1 and 2.0 data service today, is a form of data compression but is limited to the header portion of a frame or packet (also called “datagram”), and does not attempt compression on the larger payload portion of the frame or packet.

Accordingly, there is a need for data compression in data services over a cable modem to provide a higher effective throughput.

### SUMMARY OF THE INVENTION

A method for compression in cable data service includes the steps of providing data over protocol layers, and compressing at a data over cable service interface specification layer within the protocol layers. Compressing at the data over cable service interface specification layer includes compression at all layers of the protocol layers higher than the data over cable service interface specification layer.

Alternatively, a method for compression in cable data service includes providing data over protocol layers, and compressing data in a network protocol layer higher than at a data over cable service interface specification layer.

### BRIEF DESCRIPTION OF THE DRAWINGS

A more complete understanding of the present invention may be obtained from consideration of the following description in conjunction with the drawings, in which:

FIG. 1 is a diagram of protocol layers necessary to view a web page; and

FIG. 2 is a diagram showing compression of the layers of FIG. 1 resulting from compression of the DOCSIS MAC payload data unit in accordance with the invention.

### DETAILED DESCRIPTION

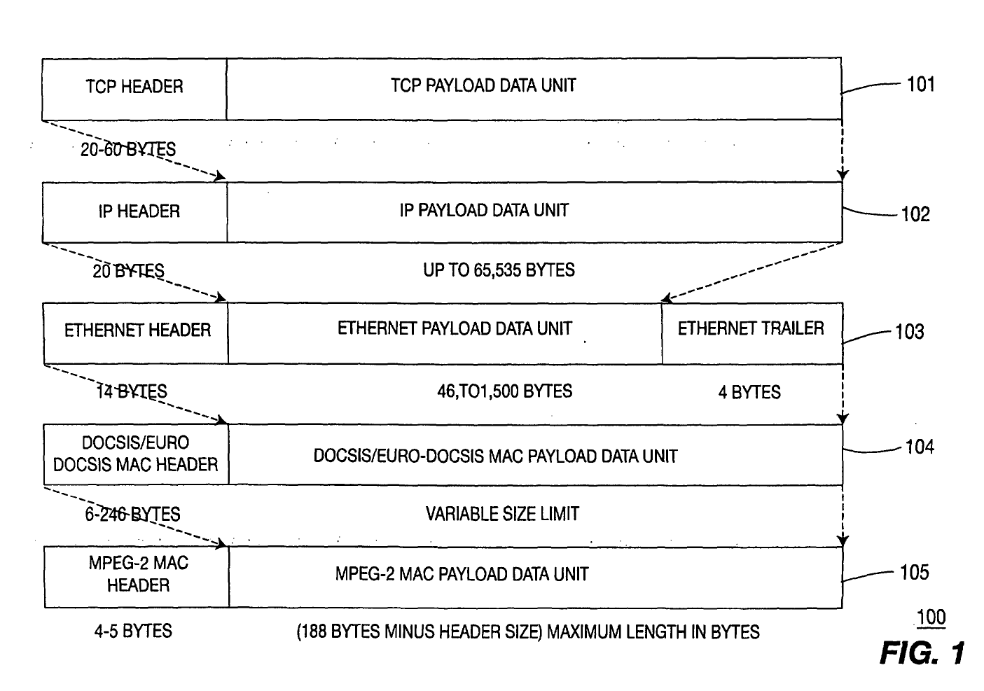

As a reference for discussion, the diagram 100 of FIG. 1 shows the protocol layers necessary to view a web page. Data compression could take two forms in frame-based or packet-based networks: header suppression/compress and payload compression. Frame-based and packet-based networks, such as an Ethernet or DOCSIS/Euro-DOCSIS network, have a Physical layer interface (not shown in FIG. 1), a Data Link layer (which includes the Media Access Control (MAC) sub-layer) (diagrams 103, 104, and 105 in FIG. 1), a Network layer (diagram 102 in FIG. 1), a Transport layer (diagram 101 in FIG. 1), and higher layer functions following the Open Systems Interconnection (OSI) model as specified in ITU-T X.200. Communication objects within the Data Link layer are broken into “frames” while objects within the Network layer are broken into “packets”. In general, frames and packets consist of a header, a payload data unit (PDU), and a trailer, as shown by the Ethernet packet frame diagram 103 of FIG. 1. The header identifies the purpose of the frame/packet, its destination address, and may include error correction information. The PDU is the data being carried by the frame or packet. A Data Link frame's PDU carries data from one peer to another peer, and that data may be all or a fragment of a MAC frame or, if the network uses three layers or more, a packet. The trailer usually is another form of error detection or correction.

The DOCSIS/Euro-DOCSIS specifications, which define a network with. a minimum of five layers, recognized that the overhead imposed by headers reduced the bandwidth available to the more important PDU and implemented “Payload Header Suppression (PHS)” to compress the Ethernet media access control MAC header and TCP/UDP/IP packet header in the MAC PDU. A cable data service based on DOCSIS/Euro-DOCSIS specifications uses a TCP/UDP 101 within IP packets 102, contained in Ethernet MAC frames 103, contained in DOCSIS/Euro-DOCSIS MAC frames 104, contained in MPEG-2 frames 105. Payload header suppression PHS provides a standard method of compressing the headers associated with the TCP/UDP/IP packets and Ethernet frames. However, PHS only provides header suppression/compression between the cable modem and the Cable Modem Termination System (CMTS) in the head-end of the cable data service provider. It does not provide end-to-end header suppression/compression from cable modem CM to cable modem CM or from consumer application to a peer application. Therefore, it does not reduce bandwidth requirements on the consumer local area network (LAN), the cable companies LAN, the Internet (or other wide area network), nor the LAN (if any) at the terminating end. One aspect of this proposal is to use TCP/UDP/IP header suppression/compression standards defined by the Internet Engineering Task Force (IETF) to provide end-to-end compression and increase end-to-end throughput efficiency. For example, the IETF has defined RFC2507 (“IP Header Compression”), RFC2508 (“Compressing IP/UDP/RTP Headers for Low-Speed Serial Links”), RFC3095 (“RObust Header Compression (ROHC): Framework and four profiles”), and RFC3545 (“Enhanced Compressed RTP (CRTP) for Links with High Delay, Packet Loss and Reordering”). It may be necessary to modify or redefine the control mechanism to adapt these standard header suppression/compression methods to use in DOCSIS/Euro-DOCSIS networks. Using these standard header suppression and compression methods will not prevent the use of payload header suppression DOCSIS/Euro-DOCSIS PHS, although they may reduce the effectiveness of DOCSIS/Euro-DOCSIS PHS.

The other area of compression opportunity is in compressing the PDU field of the packet and/or the frame. Compressing the PDU is a more attractive method for increasing effective bandwidth because the size of the PDU is much larger than the corresponding header. For example, the largest Ethernet frame is 1518 bytes of which four bytes are the “trailer” and the header uses about 40 bytes, so the maximum PDU is about 1474 bytes. The second aspect of this proposal is to use standard payload compression methods on either or both of the frames and packet PDU used in DOCSIS/Euro-DOCSIS networks. For example, RFC3173 (“IP Payload Compression Protocol (IPComp)”), RFC2394 (“IP Payload Compression Using DEFLATE”), RFC2395 (“IP Payload Compression Using LZS”), RFC3051 (“IP Payload Compression Using ITU-T V.44 Packet Method”), and ITU-T Recommendation V.44 (“Data Compression Procedures”) define a PDU compression method suitable for use in DOCSIS/Euro-DOCSIS networks.

PDU compression could occur at the Data Link/MAC layer or the Network layer with different advantages to each choice. PDU compression at the Network layer would provide less overall compression than at the Data Link/MAC layer, although it is more suitable to end-to-end compression. However, in cable data service using DOCSIS/Euro-DOCSIS specifications, the handshake between the cable modem and the far-end is less likely to establish PDU compression because the far-end system is less likely to have implemented the matching PDU compression method, such as RFC3173 and RFC3051. PDU compression at the Data Link/MAC layer could have a higher probability of completing the PDU compression handshake if the DOCSIS/Euro-DOCSIS specifications were altered to adopt PDU compression; then MAC layer communication between the cable modem and CMTS would implement PDU compression. With PDU compression at the Data Link/MAC layer the local cable service company and cable data service consumer would attain the benefits of PDU compression, such as higher data throughput and more efficient use of the cable spectrum.

Again, FIG. 1 shows the protocol layers necessary to transfer web page data between a consumer and the Internet using TCP/IP over a DOCSIS/Euro-DOCSIS cable data service. FIG. 1 illustrates the multiple headers required but does not include the additional header overhead necessary because the TCP/EP packet must be fragmented into multiple frames to fit within the 184 byte payload limitation of an MPEG-2 frame. Header suppression/compression at the Ethernet MAC and higher layers would improve data transfer efficiency although the original TCP/IP packet will still require fragmentation.

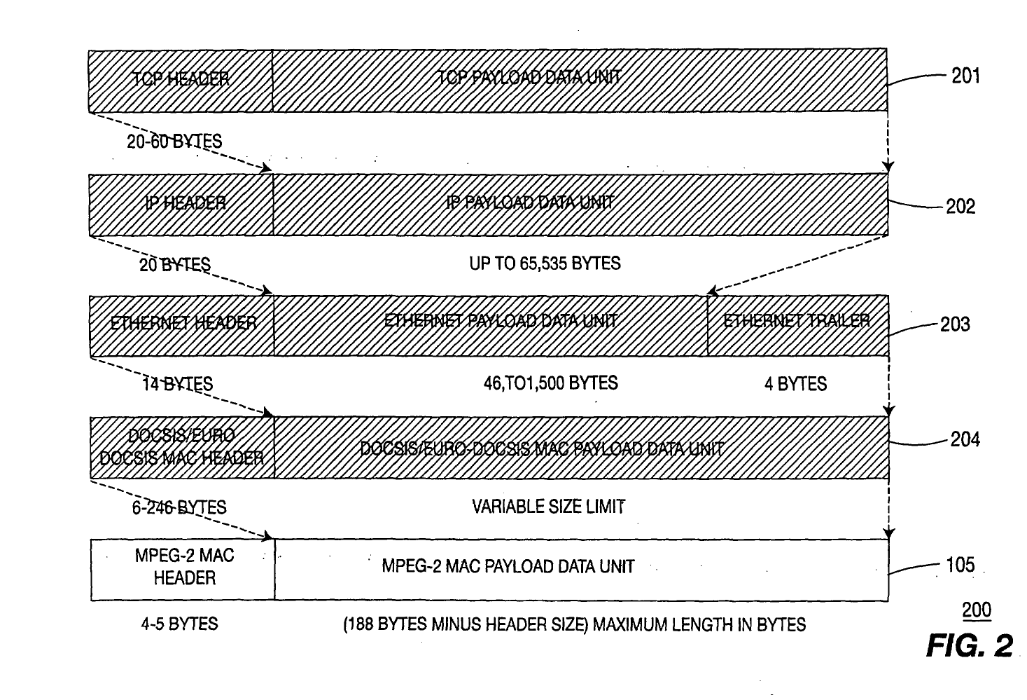

The diagram 200 of FIG. 2 illustrates PDU compression implemented at the DOCSIS/Euro-DOCSIS MAC layer. PDU compression at this layer will also compress the headers associated with the Ethernet MAC and higher layers because they are part of the “payload data” for the DOCSIS/Euro-DOCSIS MAC layer. PDU compression will improve overall data transfer efficiency more than header suppression/compression alone. Although various embodiments which incorporate the teachings of the present invention have been shown and described in detail herein, those skilled in the art can readily devise many other varied embodiments that will still incorporate these teachings.

1. A method for compression in cable data service comprising the steps of:
receiving data over protocol layers through a cable modem; and
compressing data over cable service, wherein said compressing data over cable service includes compressing at least a payload data unit field at a data over cable service interface specification layer within said protocol layers.

2. The method of claim 1, wherein said step of compressing said data over cable service includes compression at all layers of said protocol layers higher than a data over cable service interface specification layer.

3. The method of claim 1, wherein said step of compressing said data over cable service includes compression of a transport control protocol layer.

4. The method of claim 1, wherein said step of compressing said data over cable service includes compression of an Internet protocol layer.

5. The method of claim 1, wherein said step of compressing said data over cable service includes compression of an Ethernet protocol layer.

6. The method of claim 1, wherein said step of compressing said data over cable service comprises compression only of a media access control layer of a payload data unit of said data over cable service layer.

7. The method of claim 2, wherein an MPEG-2 media access control layer below said data over cable service interface specification layer remains uncompressed.

8. A method for compression in cable data service comprising the steps of:
receiving data over protocol layers via a cable modem for viewing a web page; and
compressing at least a payload data unit field of a data over cable service interface specification layer within said protocol layers.

9. The method of claim 8, wherein said step of compressing at said data over cable service interface specification includes compression of layers of said protocol layers included within said data over cable service interface specification layer.

10. The method of claim 9, wherein said layers of said protocol layers included within said data over cable service interface specification layer include at least one of a transport control protocol layer, an Internet protocol layer, and an Ethernet protocol layer.

11. (canceled)
